(19) United States
(12) Patent Application Publication
(10) Pub. No.: US 2024/0078478 A1
(43) Pub. Date: Mar. 7, 2024

(54) RESULTANT ACOUSTICS FIELD-BASED WORKPLACE LEVEL CONTROL

(71) Applicant: INTERNATIONAL BUSINESS MACHINES CORPORATION, ARMONK, NY (US)

(72) Inventors: Jeremy R. Fox, Georgetown, TX (US); Martin G. Keen, Cary, NC (US); Tushar Agrawal, West Fargo, ND (US); Sarbajit K. Rakshit, Kolkata (IN)

(21) Appl. No.: 17/929,048

(22) Filed: Sep. 1, 2022

(51) Int. Cl. G06Q 10/06; G10K 11/16

(52) U.S. Cl. CPC G06Q 10/063; G10K 11/16

(57) ABSTRACT

According to one embodiment, a method, computer system, and computer program product for determining acoustics in a workplace is provided. The present invention may include performing digital twin simulation of sound generation and at least one machine in the workplace; calculating one or more resultant sound fields in the workplace; identifying sound cancellation potential of a worker's sound cancellation protection; and determining if the worker is wearing proper sound cancellation protection based on the one or more resultant sound fields in the workplace and the sound cancellation potential of the worker's sound cancellation protection.

### BACKGROUND

The present invention relates, generally, to the field of computing, and more particularly to digital audio.

Digital audio is a technology that is used to record, store, manipulate, generate, and reproduce sound. Digital audio converts sound waves into electrical signals, and thus, a digital form. In an industrial workplace setting, workers can experience varying sound levels on the decibel scale produced by machines. Currently, sound level meters, integrating sound level meters, and dosimeters, can be used to measure the sound levels. Additionally, workers can wear sound protection to protect themselves from harmful sound levels. However, sound levels may vary considerably based on both where a worker is located in the workplace and diversions in the sound produced by the machines. Therefore, it may be necessary for a worker to know the decibel levels in each location they visit during a workday and if more sound protection is needed to ensure the worker is not exposed to harmful sound levels. Thus, an improvement in digital audio has the potential to benefit workers in the industrial workplace.

### SUMMARY

According to one embodiment, a method, computer system, and computer program product for determining acoustics in a workplace is provided. The present invention may include performing digital twin simulation of sound generation and at least one machine in the workplace; calculating one or more resultant sound fields in the workplace; identifying sound cancellation potential of a worker's sound cancellation protection; and determining if the worker is wearing proper sound cancellation protection based on the one or more resultant sound fields in the workplace and the sound cancellation potential of the worker's sound cancellation protection.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application environment according to at least one embodiment;

FIG. 3 is an operational flowchart illustrating a workplace acoustics determination process according to at least one embodiment;

FIG. 4 is a system diagram illustrating an exemplary program environment of an implementation of a workplace acoustics determination process according to at least one embodiment; and

FIG. 5 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In an industrial workplace, varying sound levels can be produced that may be harmful to a worker's hearing. Exposure to high sound levels can lead to health problems, such as loss of hearing, if proper sound protection is not worn. For example, a worker may be wearing earplugs at their workstation that may be sufficient to cancel out harmful waves in the resultant sound field around the worker's workstation. However, the worker may be spending around 40% of their days in a different location of the workspace where the earplugs may not be sufficient enough to block out higher sound levels than the sound levels that are present at the worker's workstation. Therefore, it may be likely that a worker may still be exposed to harmful sound waves even if the worker is wearing some form of sound protection.

One way in which current methods attempt to address problems with exposing workers to harmful sound waves is to ensure the workers are wearing proper sound protection capable of blocking out the harmful sound waves. Specifically, current methods may alert a worker if they are not wearing hearing protection. For example, a device can be used to alert a worker if a high noise level is detected, and hearing protection is needed. However, several deficiencies exist in monitoring noise data and alerting workers based on the detection of high noise levels. One of the deficiencies in the detection of high noise levels is that it is a static method. For example, current methods may only measure sound levels in one location, and not in multiple locations and/or continuously while the worker is moving around a workplace. Another deficiency in the detection of high noise levels is that current methods are reactive and not proactive. For example, a worker may not know if they are wearing sufficient sound cancellation protection before undergoing an operation in the workplace, and are only made aware of the fact after the worker has begun. Thus, an improvement in digital audio has the potential to reduce a worker's exposure to harmful sound levels and thus, benefit workers in an industrial workplace.

The present invention has the capacity to improve digital audio by calculating the resultant sound field around the physical location of a worker to determine if the worker is wearing appropriate sound cancellation protection. Accordingly, it may be advantageous to, among other things, implement a system that improves the determination of whether a worker is wearing proper sound cancellation protection based upon the operation a worker is performing and one or more locations of the worker. For example, the sound cancellation potential of the worker's sound cancellation protection can be measured against the sound generated during the operation the worker is performing and the one or more locations the worker will be positioned at during the performance of the operation. This improvement in the determination of whether a worker is wearing proper sound cancellation protection can be accomplished by implementing a system that performs a digital twin simulation of the machinery, connectors, and sound generation levels per operation, identifies the worker's sound cancellation potential based on the operation the worker is performing and the one or more positions of the worker, determines if proper sound cancellation protection is being worn by the worker, notifies the worker if their sound cancellation protection is improper, and assigns a robotic system to replace the worker or notifies the worker's superior if the worker does not improve their sound cancellation potential.

According to one embodiment, the invention is a system, method, and/or computer program product for utilizing digital twin simulation to both calculate the resultant sound field generation in a workplace based on one or more of a worker's positions and machinery usage, and identify the sound cancellation potential of a worker's sound cancellation protection, to determine if the worker is wearing sufficient sound cancellation protection.

In some embodiments of the invention, the workplace acoustics determination program, herein referred to as “the program”, may perform a digital twin simulation of the machinery and connectors in the workplace. A workplace may be a place at which one or more persons work. A digital twin simulation can be a virtual representation of an object or system and is updated from real-time data and may use simulations to help decision-making. Digital twin simulation may be performed using artificial intelligence systems such as Maximo® (Maximo® and all Maximo®-based trademarks and logos are trademarks or registered trademarks of International Business Machines Corporation, and/or its affiliates). The digital twin simulation may be performed by identifying the relative position of machinery and connectors in the workplace. Specifically, the program may identify each machine and its relative positive in the workplace, as well as the connectors of the machines, such as conveyors and pipelines. Additionally, the program may identify the structure of the workplace, such as various air passages that may create an air column effect. Also, the program may identify the material used in the workplace and determine if certain materials have any effect on a resultant sound field.

The program may perform a digital twin simulation of the sound generation per operation in the workplace. The digital twin simulation sound generation may be performed by simulating how much sound is generated in different locations of the workplace, and simulating the resultant sound fields at different locations in the workplace. The digital twin simulation can be performed for each operation a worker conducts in the workplace. An operation refers to a task performed in the workplace, such as running a certain machine, driving a forklift around a warehouse, and/or operating a packaging line. A worker may be a person who is performing labor and/or assisting in the performance of labor at the workplace.

The program may calculate the sound generation for each operation and each position in the workplace. The program may use acoustic classification to calculate resultant sound fields in different locations/portions of the workplace. Upon identifying a worker's physical position in the workplace, the program may calculate the resultant sound field around the physical position of the worker. Also, the program may calculate the resultant sound field along the mobility path of the workers. Additionally, the program may determine the sound generation for each operation occurring in the workplace based on the machines each operation requires and a simulation of how much sound each operation generates. Also, the program may calculate how much sound can be lowered and/or canceled in different scenarios, such as if a certain machine was not running and/or if a piece of equipment that had a loose part, had that part fixed.

In some embodiments of the invention, the program may determine if certain machines need to be replaced, need to have one or more parts replaced, or if maintenance needs to be performed on the instrument. The program may make such a determination by detecting differences in the resultant sound field generated in a certain location. For example, if the program calculates the sound generation in a physical location that is 20% higher than usual, the program may determine that a certain machine near the physical location requires maintenance based on producing higher than usual sound waves.

In some embodiments of the invention, the program may access control of a machine in the workplace. The program may access control of a machine and for example, turn it off, thus lowering harmful sound waves. The program may control a machine using smart device technologies.

The program may identify the sound cancellation potential of the worker's sound cancellation protection based on the operation the worker is performing and one or more locations of the worker during the performance of the operation. The program may identify the sound cancellation potential by determining what type of sound cancellation protection is being worn by a worker. Sound cancellation protection may be an internet of things (IoT) pair of headphones and/or a piece of equipment used for hearing protection. The program may analyze whether the worker is wearing sufficient sound cancellation equipment to block out certain levels of noise exposure based on if the sound cancellation equipment is being worn properly and/or if the resultant sound field generation in one or more locations is greater than the sound that the sound cancellation protection may block during the performance of an operation.

The program may determine if the worker's sound cancellation protection is sufficient to block out harmful levels of noise exposure. The program may determine if the worker's sound cancellation protection is sufficient by measuring the sound cancellation capabilities of the worker's IoT sound cancellation headphones. The program may compare the sound cancellation capabilities of the worker's IoT sound cancellation headphones to the sound generation for each operation that the worker is performing in the workplace. Additionally, the program may compare the sound cancellation capabilities of the worker's IoT sound cancellation headphones to the sound generation at each position in the workplace that the worker may be stationed at and/or traversing through.

IoT sound cancellation headphones may be any device capable of recording, storing, generating, and reproducing sound. The IoT sound cancellation headphones, also referred to as sound cancellation protection, can comprise sound level meters, integrating sound level meters, and/or dosimeters that can measure sound levels. Additionally, the IoT sound cancellation headphones can comprise an apparatus that converts electrical impulses into sound, such as a loudspeaker, speaker driver, and/or one or more speakers.

According to one implementation, if the program determines that the worker's sound cancellation protection is sufficient, the program may conclude running the current workplace acoustics determination process. The program may determine that the worker's sound cancellation protection is sufficient if the measured sound cancellation capabilities of the worker's IoT sound cancellation headphones are greater than the measured sound generation for each operation the worker performs in the workplace and each position the worker traverses or is stationed in the workplace. If the program determines that the worker's sound cancellation protection is not sufficient, the program may proceed to notify the worker of the insufficient sound cancellation protection. The program may determine that the worker's sound cancellation protection is not sufficient if the measured sound cancellation capabilities of the worker's IoT sound cancellation headphones are less than the measured sound generation for each operation the worker performs in the workplace and/or each position the worker traverses in the workplace.

The program may notify a worker of the insufficient sound cancellation protection worn by the worker. The program may notify a worker of their insufficient sound cancellation protection by alerting the worker with the output of a certain noise by the worker's device and/or with the display of a prompt on the worker's viewing device that the user can click. For example, a prompt may appear on the worker's viewing device notifying the worker that their sound cancellation protection is insufficient and displaying text such as, “has sound cancellation protection been adjusted?” The worker may then select either “Yes” or “No” to proceed. The worker's viewing device may be a screen on a computer, phone, and/or any device capable of displaying images.

The program can check if a worker adjusted their sound cancellation protection after being notified of insufficient sound cancellation protection. The program can check if a worker adjusted their sound cancellation protection based on the input a worker gives in response to the prompt shown on the worker's viewing device.

According to one implementation, if the program determines that the worker adjusted their sound cancellation protection, the program may proceed to identify the sound cancellation potential based upon the operation and one or more positions of the worker. A worker may adjust their sound cancellation protection by, for example, adjusting the protection so that the worker is properly wearing the protection and/or wearing a different piece of sound cancellation protection that has a higher threshold of sound cancellation. If the program determines that the worker did not adjust their sound cancellation protection, the program may proceed to assign a robotic system to replace the worker.

In some embodiments of the invention, the program may assign a robotic system to replace a worker. The program may determine if there is a robotic system available to replace the worker in the workplace. If there is a robotic system available to replace the worker, the program may assign the robotic system to conduct the operation the worker is performing. The program may assign a robotic system to replace a worker when the worker does not adjust their sound cancellation protection to achieve a sound cancellation potential sufficient to meet the minimum level needed for blocking out harmful sound exposure levels.

In some embodiments of the invention, the program may notify one or more of the worker's superiors of insufficient sound cancellation protection. A superior may be any person who is higher in station, rank, degree, and/or importance than the worker at the worker's workplace. If the program determines that there is no robotic system available to replace the worker, then the program may notify one or more of the worker's superiors of the worker's insufficient sound cancellation protection. The program may notify the worker's superior by displaying a prompt on the superior's IoT device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to perform a digital twin simulation of machinery and sound generation, identify the worker's sound cancellation potential based on the operation the worker is performing and the one or more positions of the worker, determine if proper sound cancellation protection is being worn by the worker, notify the worker if improper sound cancellation protection is being worn, and assign a robotic system to replace the worker or notify one or more of the worker's superiors if the worker does not improve their sound cancellation potential.

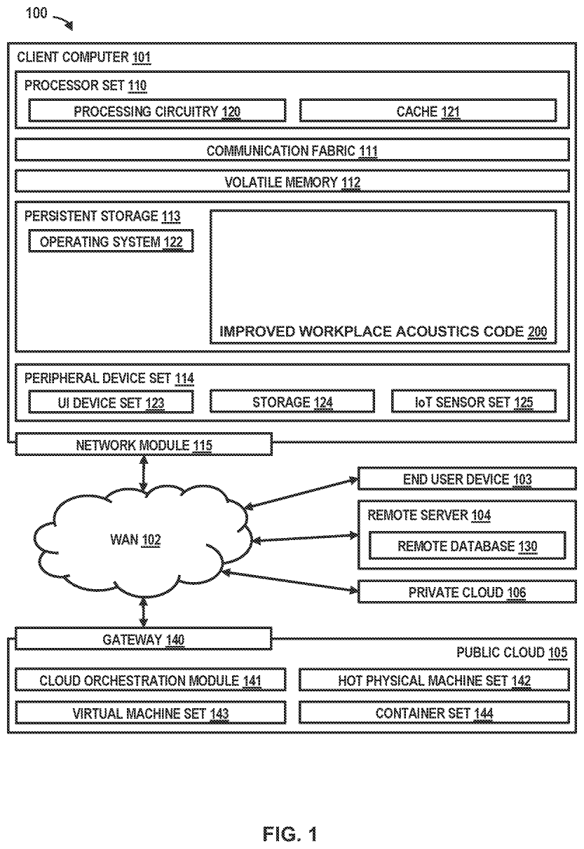

Referring to FIG. 1, an exemplary networked computer environment 100 is depicted, according to at least one embodiment. Computing environment 100 contains an example of an environment for the execution of at least some of the computer code involved in performing the inventive methods, such as improved workplace acoustics code 200. In addition to code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

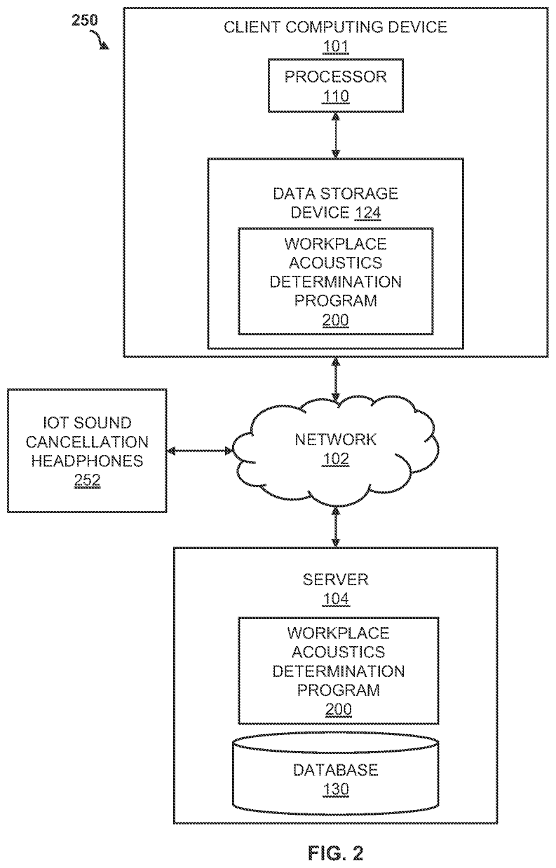

Referring to FIG. 2, an exemplary application environment 250 is depicted, according to at least one embodiment. The application environment 250 may include client computing device 101 and a remote server 104 interconnected via a communication network 102. According to at least one implementation, the application environment 250 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

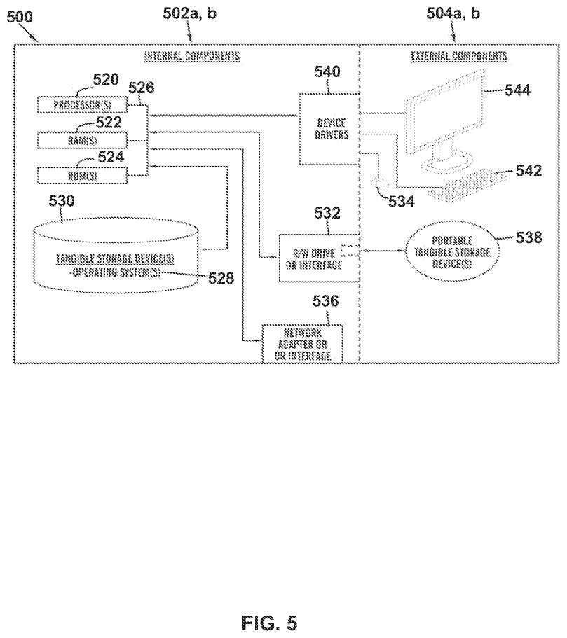

Client computing device 101 may include a processor 110 and a data storage device 124 that is enabled to host and run a workplace acoustics determination program 200 and communicate with the remote server 104 via the communication network 102, in accordance with one embodiment of the invention. As will be discussed with reference to FIG. 5, the client computing device 101 may include internal components 502a and external components 504a, respectively.

The remote server computer 104 may be a laptop computer, netbook computer, personal computer (PC), a desktop computer, or any programmable electronic device or any network of programmable electronic devices capable of hosting and running a virtual reality object properties determination program 200 and a database 130 and communicating with the client computing device 101 via the communication network 102, in accordance with embodiments of the invention. As will be discussed with reference to FIG. 5, the remote server computer 104 may include internal components 502b and external components 504b, respectively. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102.

IoT sound cancellation headphones 252 may be any device capable of recording, storing, generating, and reproducing sound. The IoT sound cancellation headphones 252 can comprise sound level meters, integrating sound level meters, and/or dosimeters that can measure sound levels. Additionally, the IoT sound cancellation headphones 252 can comprise an apparatus that converts electrical impulses into sound, such as a loudspeaker, speaker driver, and/or one or more speakers.

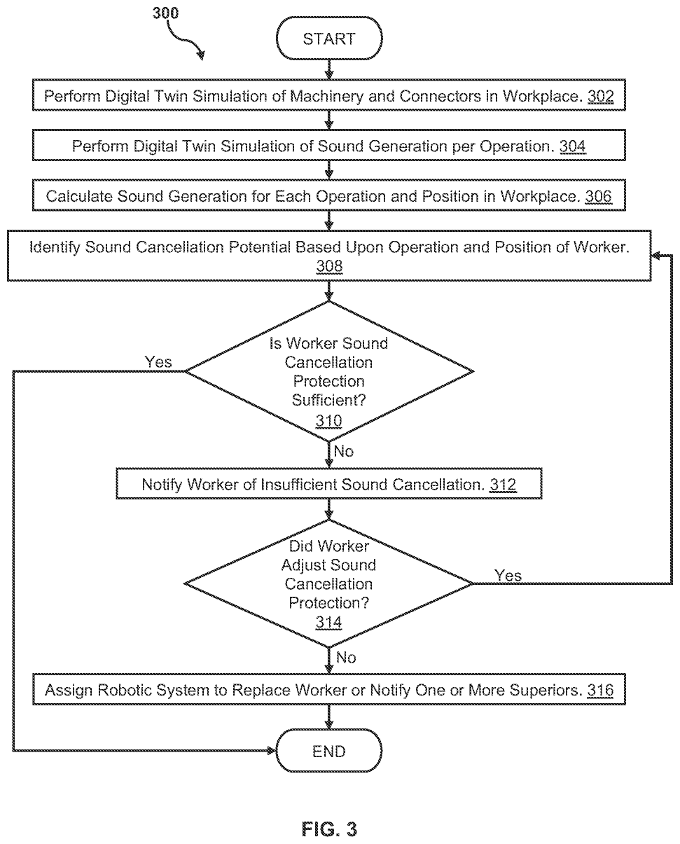

According to the present embodiment, the workplace acoustics determination program 200 may be a program 200 capable of performing digital twin simulation of at least one machine and sound generation in a workplace, identifying sound cancellation potential of a worker's sound cancellation protection, and determining if the worker is wearing proper sound cancellation protection based on the one or more resultant sound fields in the workplace and the sound cancellation potential of the worker's sound cancellation protection. The program 200 may be located on client computing device 101 or remote server 104 or on any other device located within network 102. Furthermore, the workplace acoustics determination program 200 may be distributed in its operation over multiple devices, such as client computing device 101 and remote server 104. The workplace acoustics determination method is explained in further detail below with respect to FIG. 3.

Referring now to FIG. 3, an operational flowchart illustrating a workplace acoustics determination process 300 is depicted according to at least one embodiment. At 302, the program 200 performs a digital twin simulation of the machinery and connectors in the workplace. The program 200 may perform a digital twin simulation by identifying the relative position of machinery and connectors in the workplace. Specifically, the program 200 may identify each machine and its relative positive in the workplace, as well as the connectors of the machines, such as conveyors and pipelines. Additionally, the program 200 may identify the structure of the workplace, such as various air passages that may create an air column effect. Also, the program 200 may identify the material used in the workplace and determine if certain materials have any effect on a resultant sound field.

At 304, the program 200 performs a digital twin simulation of the sound generation per operation in the workplace. The program 200 may perform digital twin simulation sound generation by simulating how much sound is generated in different locations of the workplace, and simulating the resultant sound fields at different locations in the workplace. The program 200 may perform a digital twin simulation for each operation a worker conducts in the workplace.

At 306, the program 200 calculates the sound generation for each operation and each position in the workplace. The program 200 may use acoustic classification to calculate resultant sound fields in different locations/portions of the workplace. Upon identifying a worker's physical position in the workplace, the program 200 may calculate the resultant sound field around the physical position of the worker. Also, the program 200 may calculate the resultant sound field along the mobility path of the workers. Additionally, the program 200 may determine the sound generation for each operation occurring in the workplace based on the machines each operation requires and a simulation of how much sound each operation generates. Also, the program 200 may calculate how much sound can be lowered and/or canceled in different scenarios.

In some embodiments of the invention, the program 200 may determine if certain machines need to be replaced, need to have one or more parts replaced, or if maintenance needs to be performed on the instrument. The program 200 may make such a determination by detecting differences in the resultant sound field generated in a certain location.

At 308, the program 200 identifies the sound cancellation potential based on the operation and position of a worker. The program 200 may identify the sound cancellation potential of the worker's sound cancellation protection equipment, herein referred to as sound cancellation protection, based on the operation the worker is performing and one or more locations of the worker during the performance of the operation. The program 200 may identify the sound cancellation potential by determining what type of sound cancellation protection is being worn by a worker. The program 200 may analyze whether the worker is wearing sufficient sound cancellation equipment to block out certain levels of noise exposure based on if the sound cancellation equipment is being worn properly and/or if the resultant sound field generation in one or more locations is greater than the sound that the sound cancellation protection may block during the performance of an operation.

At 310, the program 200 determines if the worker's sound cancellation protection is sufficient to block out harmful levels of noise exposure. The program 200 may determine if the worker's sound cancellation protection is sufficient by measuring the sound cancellation capabilities of the worker's IoT sound cancellation headphones. The program 200 may compare the sound cancellation capabilities of the worker's IoT sound cancellation headphones to the sound generation for each operation that the worker is performing in the workplace. Additionally, the program 200 may compare the sound cancellation capabilities of the worker's IoT sound cancellation headphones to the sound generation at each position in the workplace that the worker may be stationed at and/or traversing through.

According to one implementation, if the program 200 determines that the worker's sound cancellation protection is sufficient (step 310, “Yes” branch), the program 200 may conclude running the workplace acoustics determination process 300. If the program 200 determines that the worker's sound cancellation protection is not sufficient (step 310, “No” branch), the program 200 may proceed to step 312 to notify the worker of the insufficient sound cancellation protection.

At 312, the program 200 notifies the worker of the insufficient sound cancellation protection worn by the worker. The program 200 may notify a worker of their insufficient sound cancellation protection by alerting the worker with the output of a certain noise by the worker's device and/or with the display of a prompt on the worker's viewing device that the user can click. The worker's viewing device may be a screen on a computer, phone, and/or any device capable of displaying images.

At 314, the program 200 checks if the worker adjusted their sound cancellation protection. The program 200 can check if a worker adjusted their sound cancellation protection based on the input a worker gives in response to the prompt shown on the worker's viewing device.

According to one implementation, if the program 200 determines that the worker adjusted their sound cancellation protection (step 314, “Yes” branch), the program 200 may proceed back to step 308 to identify the sound cancellation potential based on the operation and position of the worker. If the program 200 determines that the worker did not adjust their sound cancellation protection (step 314, “No” branch), the program 200 may proceed to step 316 to replace the worker with an assigned robotic system or notify one or more of the worker's superiors of the worker's insufficient sound cancellation protection.

At 316, the program 200 may either assign a robotic system to replace the worker or notify one or more of the worker's superiors of the worker's insufficient sound cancellation protection. The program 200 may determine if there is a robotic system available to replace the worker in the workplace. If there is a robotic system available to replace the worker, the program 200 may assign the robotic system to conduct the operation the worker is performing. If there is no robotic system available to replace the worker, then the program 200 may notify one or more of the worker's superiors of the worker's insufficient sound cancellation protection. The program 200 may notify the worker's superior by sending a prompt to the superior's IoT device.

In some embodiments of the invention, the program 200 may access control of a machine in the workplace. The program 200 may access control of a machine and turn it off, thus lowering harmful sound waves. The program 200 may control a machine using smart device technologies.

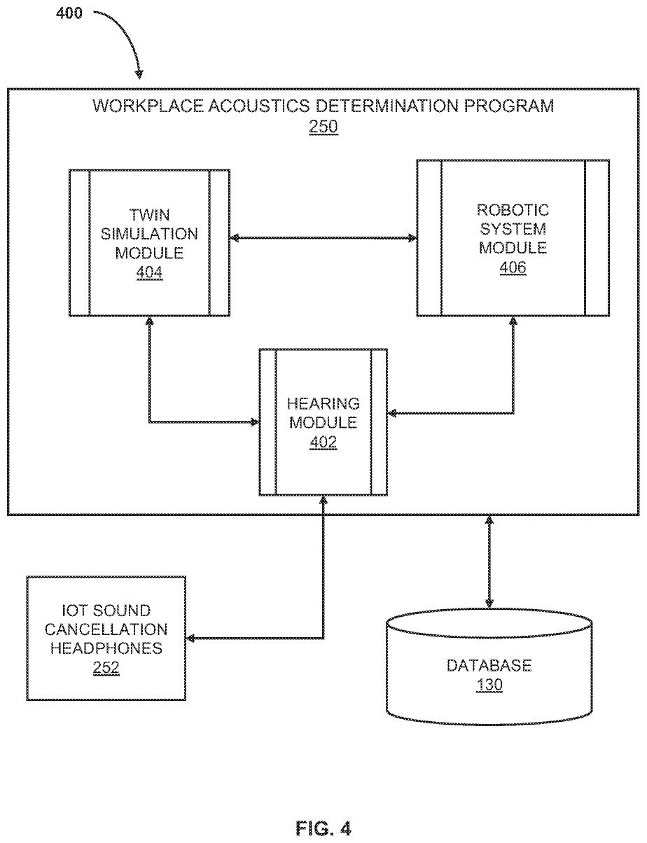

Referring now to FIG. 4, a system diagram illustrating an exemplary program environment 400 of an implementation of a workplace acoustics determination process 300 is depicted according to at least one embodiment. Here, the program 200 comprises a hearing module 402, a twin simulation module 404, and a robotic system module 406. The exemplary program environment 400 details the interactions between the hearing module 402 and the twin simulation module 404, the hearing module and the robotic system module 406, and the twin simulation module 404 and the robotic system module 406. Additionally, the exemplary program environment 400 details the interactions between the hearing module 402 and the IoT sound cancellation headphones 252, and the workplace acoustics determination program 200 and the database 130.

The hearing module 402 may be used to calculate the sound generation of the workplace. The twin simulation module 404 may be used to perform twin simulation of the machinery, connectors, and/or sound generation in the workplace. The robotic system module 406 may be used to assign a robotic system to replace a worker.

It may be appreciated that FIGS. 2 through 4 provide only illustrations of one implementation and do not imply any limitations with regard to how different embodiments may be implemented. Many modifications to the depicted environments may be made based on design and implementation requirements.

FIG. 5 is a block diagram 500 of internal and external components of the client computing device 101 and the remote server 104 depicted in FIG. 1 in accordance with an embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

The data processing system 502, 504 is representative of any electronic device capable of executing machine-readable program instructions. The data processing system 502, 504 may be representative of a smart phone, a computer system, PDA, or other electronic devices. Examples of computing systems, environments, and/or configurations that may be represented by the data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 101 and the remote server 104 may include respective sets of internal components 502 a, b and external components 504 a, b illustrated in FIG. 5. Each of the sets of internal components 502 include one or more processors 520, one or more computer-readable RAMs 522, and one or more computer-readable ROMs 524 on one or more buses 526, and one or more operating systems 528 and one or more computer-readable tangible storage devices 530. The one or more operating systems 528, the workplace acoustics determination program 200 in the client computing device 101, and the workplace acoustics determination program 200 in the remote server 104 are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502 a, b also includes a R/W drive or interface 532 to read from and write to one or more portable computer-readable tangible storage devices 538 such as a CD-ROM, DVD, memory stick, magnetic tape, magnetic disk, optical disk or semiconductor storage device. A software program, such as the workplace acoustics determination program 200, can be stored on one or more of the respective portable computer-readable tangible storage devices 538, read via the respective R/W drive or interface 532, and loaded into the respective hard drive 530.

Each set of internal components 502 a, b also includes network adapters or interfaces 536 such as a TCP/IP adapter cards, wireless Wi-Fi interface cards, or 3G or 4G wireless interface cards or other wired or wireless communication links. The workplace acoustics determination program 200 in the client computing device 101 and the workplace acoustics determination program 200 in the remote server 104 can be downloaded to the client computing device 101 and the remote server 104 from an external computer via a network (for example, the Internet, a local area network or other, wide area network) and respective network adapters or interfaces 536. From the network adapters or interfaces 536, the workplace acoustics determination program 200 in the client computing device 101 and the workplace acoustics determination program 200 in the remote server 104 are loaded into the respective hard drive 530. The network may comprise copper wires, optical fibers, wireless transmission, routers, firewalls, switches, gateway computers and/or edge servers.

Each of the sets of external components 504 a, b can include a computer display monitor 544, a keyboard 542, and a computer mouse 534. External components 504 a, b can also include touch screens, virtual keyboards, touch pads, pointing devices, and other human interface devices. Each of the sets of internal components 502 a, b also includes device drivers 540 to interface to computer display monitor 544, keyboard 542, and computer mouse 534. The device drivers 540, RAY drive or interface 532, and network adapter or interface 536 comprise hardware and software (stored in storage device 530 and/or ROM 524).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for determining acoustics in a workplace, the method comprising:
performing digital twin simulation of sound generation and at least one machine in the workplace;
calculating one or more resultant sound fields in the workplace;
identifying sound cancellation potential of a worker's sound cancellation protection; and
determining if the worker is wearing proper sound cancellation protection based on the one or more resultant sound fields in the workplace and the sound cancellation potential of the worker's sound cancellation protection.

2. The method of claim 1, further comprising:
notifying the worker of improper sound cancellation protection being worn.

3. The method of claim 2, further comprising:
assigning a robotic system to replace the worker.

4. The method of claim 2, further comprising:
notifying one or more of the worker's superiors of the worker's improper sound cancellation protection.

5. The method of claim 1, wherein calculating the one or more resultant sound fields in the workplace comprises calculating sound generation based on one or more of the worker's locations in the workplace and/or one or more of the worker's operations in the workplace.

6. The method of claim 1, further comprising:
determining adjustments to the workplace to lower the one or more resultant sound fields in the workplace.

7. The method of claim 1, further comprising:
controlling sound generation from the at least one machine in the workplace.

8. A computer system for determining acoustics in a workplace, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
performing digital twin simulation of sound generation and at least one machine in the workplace;
calculating one or more resultant sound fields in the workplace;
identifying sound cancellation potential of a worker's sound cancellation protection; and
determining if the worker is wearing proper sound cancellation protection based on the one or more resultant sound fields in the workplace and the sound cancellation potential of the worker's sound cancellation protection.

9. The computer system of claim 8, further comprising:
notifying the worker of improper sound cancellation protection being worn.

10. The computer system of claim 9, further comprising:
assigning a robotic system to replace the worker.

11. The computer system of claim 9, further comprising:
notifying one or more of the worker's superiors of the worker's improper sound cancellation protection.

12. The computer system of claim 8, wherein calculating the one or more resultant sound fields in the workplace comprises calculating sound generation based on one or more of the worker's locations in the workplace and/or one or more of the worker's operations in the workplace.

13. The computer system of claim 8, further comprising:
determining adjustments to the workplace to lower the one or more resultant sound fields in the workplace.

14. The computer system of claim 8, further comprising:
controlling sound generation from the at least one machine in the workplace.

15. A computer program product for determining acoustics in a workplace, the computer program product comprising:
one or more computer-readable tangible storage medium and program instructions stored on at least one of the one or more tangible storage medium, the program instructions executable by a processor to cause the processor to perform a method comprising:
performing digital twin simulation of sound generation and at least one machine in the workplace;
calculating one or more resultant sound fields in the workplace;
identifying sound cancellation potential of a worker's sound cancellation protection; and
determining if the worker is wearing proper sound cancellation protection based on the one or more resultant sound fields in the workplace and the sound cancellation potential of the worker's sound cancellation protection.

16. The computer program product of claim 15, further comprising:
notifying the worker of improper sound cancellation protection being worn.

17. The computer program product of claim 16, further comprising:
assigning a robotic system to replace the worker.

18. The computer program product of claim 16, further comprising:
notifying one or more of the worker's superiors of the worker's improper sound cancellation protection.

19. The computer program product of claim 15, wherein calculating the one or more resultant sound fields in the workplace comprises calculating sound generation based on one or more of the worker's locations in the workplace and/or one or more of the worker's operations in the workplace.

20. The computer program product of claim 15, further comprising:
determining adjustments to the workplace to lower the one or more resultant sound fields in the workplace.
